(19) United States
(12) Patent Application Publication
(10) Pub. No.: US 2009/0074375 A1
(43) Pub. Date: Mar. 19, 2009

(54) METHOD AND APPARATUS FOR FRAME ACCURATE EDITING AUDIO- VISUAL STREAMS

(75) Inventors: Kousik Sankar Ramasubramaniam, Bangalore (IN); Jacobus Wilhelmus Gerardus Welten, Asten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,227

(22) PCT Filed: Nov. 15, 2005
(86) PCT No.: PCT/IB05/53768

§ 371 Date: May 14, 2007

(30) Foreign Application Priority Data
Nov. 18, 2004 (EP) 04105888.4

(51) Int. Cl. H04N 5/93

(52) U.S. Cl. 386/52; 386/E05.001

(57) ABSTRACT

A method and apparatus are disclosed for frame accurate editing of a Mpeg stream on an storage medium by editing on a GOP level and seamlessly skipping to the frame using a pre-defined mark. According to an embodiment, the skip-start marker defined in the Blu-Ray Disc Recordable specification of the Blu-Ray standard is set appropriately on a Blu-Ray disc (BD). When such a recorded stream (30) is played from the BD using a suitable decoder model having a decoder (31), a frame buffer (33) feeding an output (35), sections cut-out during editing are skipped frame accurately and seamlessly by using said frame buffer as an intermediate buffer when jumping to an end of a section to be skipped, or a beginning of a section, respectively, depending on the playback direction.

This invention pertains in general to the field of audio-visual data streams. More particularly the invention relates to a method and device for frame accurate editing of audio-visual streams.

The state of the art high capacity storage standard is Blu-ray soon emerging on the market in consumer products. Blu-ray Disc is a radically new optical storage medium offering higher storage capacities than legacy optical storage media. One of many applications of Blu-Ray Discs (BD) will be storage of video material, and more precisely of digital audio-visual streams from e.g. camcorders, satellite transmissions etc. High-definition video recording will thus be one field taking advantage of the Blu-ray Disc, especially thanks to its very high storage capacities and high-speed data transfer rates.

Most digital video recorders record video in MPEG format. They also offer some very basic editing features. But the advanced editing features, till date, were demanding in terms of computing power, i.e. MIPS (Million Instructions Per Second) and/or memory intensive and were not possible to incorporate in consumer products, especially due to the fact that the video streams had to be decoded from MPEG format and then re-encoded again for storing in the same MPEG format.

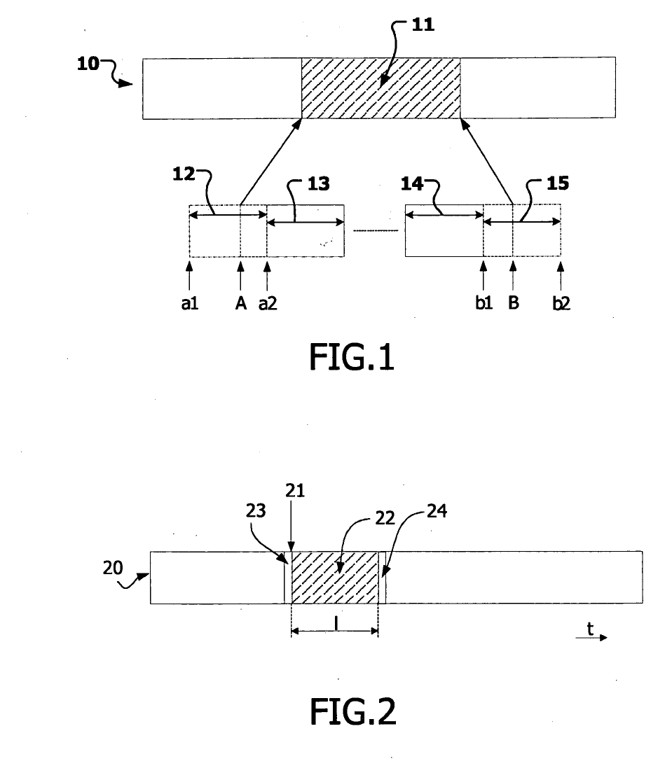

But for professional high end consumer electronics products, these basic editing features are not sufficient. Editing a video sequence involves finding the nearest GOP (Group of pictures) boundary within the audio-visual stream and then applying the editing operation. In this approach, a few frames, which the user had not intended to edit, will get edited or vice versa because of the GOP boundary calculation. In most cases, the length of a GOP is approximately half a second. This approach called as GOP-accurate editing is quite suitable for low end products, but for high end professional products, editing at GOP level is not acceptable. This is illustrated in FIG. 1, where a first GOP 12, a second GOP 13, a N-1^{st} GOP 14 and an N^{th} GOP 15 of a video sequence 10 are illustrated. GOP accurate editing means the system automatically decides to shift the point A, which indicates the start of a starting frame of a sequence of frames to be cut out of video sequence 10, to point “a1” (start of current GOP 12) or to point “a2” (start of next GOP 13). The same applies to ending point B, which is either shifted to point “b1” (end of previous GOP 14) or to point “b2” (end of current GOP 15). If the encoder has more frames in a GOP, then the situation becomes worse.

In the high end products like Blu-ray recorder, the expectation is to perform frame-accurate editing (i.e. no shifting of points A and/or B in FIG. 1). This expectation can be achieved if MPEG re-encoding is done for the GOPs around the cut GOPs (i.e. GOP 12 and GOP 15). But re-encoding MPEG is time-consuming and the hardware must have the sufficient resources like CPU power, memory etc to perform the re-encoding. Hence, there is a need for a way of avoiding MPEG re-encoding when frame accurately editing an MPEG stream.

One known idea to solve the problem of demanding resources for re-encoding a MPEG stream is to provide frame accurate seamless playback at edit points in an MPEG stream. However, a bridge sequence has to be generated and stored between the edit points, as disclosed in WO00/00981. Therefore, an object of the invention is to provide frame accurate editing without the need of generating a bridge sequence. The need is based for instance on the fact that this procedure is time-consuming due to the re-encoding of MPEG frames to create a bridge sequence because encoding of MPEG frames generally takes about 2 to 4 times more computing power than that of real-time decoding of MPEG frames. Furthermore, a bridge sequence requires extra free space on a storage medium for the MPEG stream.

Hence, an improved method and system for frame accurate editing would be advantageous and in particular a method and system for frame accurate editing being compatible with existing and preferably future standards, especially the BD standard, allowing for increased flexibility would be advantageous.

Accordingly, it is preferred to provide a method, an apparatus, a corresponding decoder and computer-readable medium comprising program code, for frame accurate editing, according to the appended patent claims.

The general solution according to the invention is to use marks defined in a standard for defining edit-in and edit-out points in an audio-visual (A/V) stream.

According to a first aspect of the invention, a method is provided for frame accurately editing an encoded audiovisual (AV) stream. The method comprises the step of employing a mark as a means of cutting out a sequence from said AV stream when editing. When the thus edited AV stream is played back, sequences in the AV stream are skipped in accordance with the edit-in and edit-out points.

According to another aspect of the invention, an apparatus is provided, which is adapted for frame accurate editing an encoded A/V stream. The apparatus, which is capable of performing the method according to the first aspect of the invention, comprises means configured for setting a mark indicating a start and duration of a sequence of frames to be skipped from said AV stream when playing said edited AV stream.

According to a further aspect of the invention, a computer-readable medium having embodied thereon a computer program for processing by a computer is provided. The computer program is provided for frame accurate editing an encoded A/V stream, for processing by a computer, and comprises a code segment for setting a mark indicating a start and duration of a sequence of frames to be skipped from said AV stream when playing said edited AV stream.

According to yet another aspect, a decoder system is provided for decoding an encoded AV stream from a storage medium. The decoder system comprises a decoder for decoding the encoded AV stream, which is configured to decode the AV stream faster than nominal speed when skipping a cut-out section, which was cut during editing, from the stream. Furthermore, a frame buffer is configured for storing decoded frames from said decoder and feeding an output for decoded frames at nominal speed, wherein the decoder is configured to stop feeding said buffer and to continue reading from said encoded stream at the beginning of a last GOP, or a first GOP depending on the playback direction, in said cut-out section being indicated by a skip-start mark configuring said stream when said mark is reached, and to continue feeding said buffer after decoding the last frame of said cut-out section configured by said skip-start mark, so that seamless playback skipping of said cut-out section is provided.

The present invention has the advantage over the prior art that it provides a fast user response because no re-encoding of MPEG frames is required. Another advantage provided by the present invention is that no extra free storage medium space is required, for instance because no bridge sequence has to be created when performing the method of the present invention.

These and other aspects, features and advantages of which the invention is capable of will be apparent and elucidated from the following description of embodiments of the present invention, reference being made to the accompanying drawings, in which

FIG. 1 is a schematic illustration of GOP-accurate editing of a MPEG-2 stream;

FIG. 2 is a schematic illustration of an example of a skip-start mark;

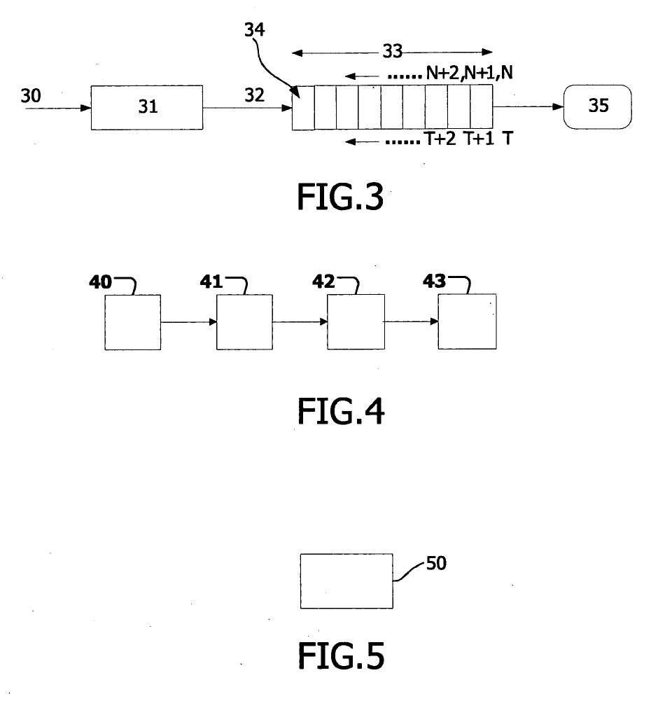

FIG. 3 is a schematic illustration of a decoder model;

FIG. 4 is a flow chart illustration an embodiment of the method according to the invention; and

FIG. 5 is a schematic illustration of an embodiment of the apparatus according to the invention.

The following description focuses on an embodiment of the present invention applicable to a Blu-Ray frame accurate editing device and in particular to a Blu-Ray recorder. However, it will be appreciated that the invention is not limited to this application but may be applied to many other A/V storage formats including for example HD-DVD, as long as markers similar to those described herein are available in a standard defining the recording format of the storage medium. The present invention may be implemented with any storage media, e.g. an optical disc, a HDD, a media card, etc.

A mark is generally defined as a pointer referenced by a time stamp on the global time axis of an AV stream represented by a title. A mark is usually used to reference highlights of characteristic scenes for playback.

Furthermore, a mark may have several attributes like a name and duration. The duration defines the length of the mark e.g. the length of a chapter mark. An application format defines the usage of several marks. One application usage of a mark is to hide the AV part identified by the length of the mark from playback. In the Blu-ray Disc specification version 1.0 this kind of mark is called a skip-start mark. This kind of mark is used for the frame accurate editing in the present embodiment of the invention, which will be described in more detail below.

An example of a skip-start mark is given in FIG. 2. An AV stream 20 is illustrated, wherein a skip-start mark defines the start 21 of a sequence 22 of frames of the AV stream to be skipped. As mentioned above, the skip-start mark comprises information about the time (t in FIG. 2) duration 1 over which the AV stream shall be skipped during playback, i.e. the playback of the AV stream ends at the end of the frame 23 before the skip-start mark and is continued with the first frame 24 after the end of the time duration indicated by the mark.

More specifically, with regard to the present embodiment, the Blu-ray standard defines skip-start marks in section 4.3.7.3 of the BD-RE (Blu-Ray Disc Recordable) specification version 1.0 along with a specifiable duration. This BD-RE specification is for instance available from Philips Intellectual Property and Systems (IP & S) at http://www.licensing.philips.com/. These BD-RE skip-start marks may be inserted at a frame accurate level. As already mentioned, the skip-start marks are an indication to a player of the recorded BD comprising such marks to skip the specified portion of the A/V stream and are usually used to hide selected scenes for playback.

It is pointed out that the skip-start mark is specifically defined for playback and as such, there is no hint or mention in the BD-RE specifications v1.0, i.e. the specification at the time the present invention was made, to use the defined playback skip marks for edit-in/out points.

A very convenient and computationally not demanding way to achieve frame accurate editing on MPEG streams compatible with the above BD-RE specification is to perform GOP accurate editing on the video stream and then to use the skip-start marks together with a maker defined data, which are specified in section 4.3.8 and section 4.3.7.3 of the above-mentioned BD-RE specification. For instance, in FIG. 1, a skip-start mark is put at point A with a duration from point A to a2 and another skip-start mark is put at point b1 with a duration from point b1 to B. The frames that belong to the skipped time period are the frames cut during editing. These cut frames need to be decoded in the background (not visible at the output) to realize the frame accurate step forward/backward.

The method is now further elucidated with reference to FIG. 4, wherein the method is illustrated with the following steps:

40 load AV stream from BD to editing device,

41 edit AV stream on a GOP level,

42 edit AV stream on frame level, and

43 write start-stop markers on BD.

In step 40 an AV stream is read from a BD to a suitable editing apparatus. The AV stream is edited on a GOP level in step 41, which is a computational advantage. The user selects a certain region of the AV stream, in which there is a sequence of frames that the user wants to cut out. When the region is identified on a GOP level, the editing is in step 42 continued on frame level, i.e. the user identifies exactly the first frame and the last frame of a sequence to be cut out from the AV stream. This sequence might be a commercial break in a movie recorded from a tv-broadcast. The user sets an edit-in point at said first frame and an edit-out point at said last frame, for instance via a suitable graphical user interface and input devices such as a mouse, a touch screen, a remote control etc. According to the method, a skip-start mark is set at the first frame and the duration is set to have a length from the first frame to the last frame of the cut out sequence. In step 43 this mark is recorded to the BD, which results in the cut-out sequence to be skipped during forthcoming playback of this BD.

Hence, according to the embodiment of the invention, BD skip-start-marks are used for editing. More precisely, the skip-start-marks, which are intended to bookmark the beginning of certain portions of a video sequence, are used for frame accurate editing. These marks are used to implement edit-in and edit-out points to aid frame accurate seamless playback, without the need to generate a bridge sequence.

One way to implement this frame accurate editing method is provided via an efficient decoder system with buffer memory between the decoder and the output. Such a decoder model is schematically illustrated in FIG. 3. This buffer 33 contains the decoded frames 34, wherein the size of this buffer depends on the speed of the decoder (faster than nominal speed 1). An encoded AV stream 30 is read from e.g. a BD into a decoder 31. The decoded frames 32 from the AV stream are put in the frame buffer 33 in a fifo manner during playback of the AV stream, i.e. frames N, N+1, N+2 are the frames at time T. T+1, T+2 etc. The buffer 33 is usually, i.e. when the decoder is not skipping cut out sections from the stream, filled with the maximum number of frames 34 from the stream of decoded frames 32 from decoder 31 (decoding faster than normal speed 1). The size of buffer 33 is suitably chosen, so that a predefined maximum number of frames fits into the frame buffer 33, preferably this is size corresponds to the maximum length (or number of frames) that a skip-start mark can indicate to skip. When the decoder 31 reaches the start 21 of a skip-start mark, it starts reading at the beginning of the last GOP in the hidden area, i.e. the area 22 as illustrated in FIG. 2 indicated by the skip-start mark. For instance in the example of FIG. 1, this is GOP 15. The decoder starts decoding the frames from this GOP in the background, not putting them into the frame buffer 33. The output 35 of the decoder model keeps outputting frames from the frame buffer 33 to guarantee seamless playback. When the decoder 31 decodes the last frame in the hidden area 22 of the skip-start mark, all the succeeding frames are put in the frame buffer again, so that seamless playback is ensured.

An application of using the BD skip-start-marks for frame accurate editing is given below.

A Blu-ray recorder 50, as shown in FIG. 5, is exposing the user feeling “What You Edit Is What You Get”, that means frame accurate editing is performed by stepping forward and backward through a recorded video, frame-by-frame. This is performed by the user to exactly find a desired scene, or to cut out the ones the user wants to discard according to the method described above. When playing the edited video, the scenes cut out by the user are skipped on a frame accurate level.

In this connection several modes of operation are possible.

For instance, in Cut mode, the scenes are identified that shall be removed. This mode is for instance suited for removing commercials from a TV program. Simply set the selection markers at the start and end of a scene and press the “Cut Button” of the Blu-ray recorder. Selected areas of the output file will not be played, while unselected areas will be played, wherein this is controlled by the start-skip marks as explained above.

Another mode is scene mode, which is just the opposite of Cut mode. Selected areas will be played, while unselected will be skipped. This operation mode is for instance used when the user wants to extract material from a video sequence. In this case, the start-skip marks are set suitably at the beginning of the unselected areas and the duration is set to the length of the unselected area, respectively.

In contrast to prior art solutions for frame accurate editing, which achieve it in a non-standard way, the above described embodiment of the invention is in conformance with the above-mentioned BD-RE standard. As maker data provided for in the BD specifications is used, the method is compatible with all other implementations of the BD specifications.

Applications and use of the above described method according to the invention are various and include exemplary fields such as the complete range of Blu-ray recording and playback products, such as consumer or professional BD recorders, BD storage solutions, etc.

Further applications of this invention also include any A/V storage applications that make use of a mark as explained above.

A further advantage of the invention is that the video payload is not edited at all. Only additional meta-data of the video, i.e. skip-start mark positions and the maker defined data is additionally written to the disc.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to a specific embodiment, it is not intended to be limited to the specific form set forth herein. Rather, the invention is limited only by the accompanying claims and, other embodiments than the specific above are equally possible within the scope of these appended claims, e.g. different marks than those described above. Furthermore, a person skilled in the art will understand that the above embodiment is based on forward play of the edited video stream and that, when reversing the playback direction of the edited video stream, the same principles apply as laid down above, only in a different direction. This means for instance that first flames are last frames in the reverse direction, etc.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method of frame accurately editing an encoded audiovisual (AV) stream comprising the step of employing a mark for cutting out a sequence of frames from said AV stream.

2. The method according to claim 1, comprising storing said mark on a storage medium when editing said AV stream.

3. The method according to claim 2, said mark being a skip-start mark.

4. The method according to claim 3, said skip-start mark defining a start and duration of said sequence of frames of said AV stream cut out during editing of said AV stream.

5. The method according to claim 4, comprising setting said skip-start mark at a first frame in playing-direction of said sequence of frames and setting the duration to a length from the first frame to the last frame of the cut out sequence of said AV stream.

6. The method according to claim 1, wherein said step of employing said mark comprises storing said mark on a storage medium on which an edited version of said AV stream is stored for enabling a seamless playback by skipping frames between edit-in and edit-out points defining said sequence of said stored edited AV stream, and wherein said mark is implementing said edit-in and edit-out points for cutting out said sequence from said AV stream.

7. The method according to claim 1, comprising GOP accurate editing the AV stream, and subsequently frame accurate editing said AV stream by employing said marker on a frame accurate level.

8. The method according to claim 1, comprising decoding said encoded AV stream from a storage medium by means of a decoder system, comprising skipping said during editing cut-out sequence from said AV stream by the steps of
decoding said encoded AV stream from a storage medium faster than nominal speed during said step of skipping,
storing decoded frames in a frame buffer and feeding an output for decoded frames at nominal speed,
stopping feeding said buffer and continue reading from said encoded AV stream at the beginning of a first or last GOP, depending on the playback direction, in said cut-out segment being indicated by a skip-start, when said mark is reached, and
continuing feeding said buffer at nominal speed after decoding the last or first frame of said cut-out section configured by said skip-start mark, depending on the playback direction,
whereby seamless playback skipping of said cut-out segment is provided at said output.

9. An apparatus (50) adapted to frame accurate editing an encoded A/V stream (30), wherein said apparatus comprises means configured for employing a mark for cutting out a sequence of frames from said AV stream.

10. The apparatus (50) according to claim 9, wherein said means are configured for setting said mark indicating a start and duration of said sequence of frames to be skipped from said AV stream when playing said edited AV stream.

11. The apparatus according to claim 9, comprising a decoder system for decoding said encoded AV stream (30) from a storage medium comprising
a decoder (31) for decoding the encoded AV stream (30), configured to decode the AV stream (30) faster than nominal speed when skipping a during editing cut-out section from said stream (30),
a frame buffer (33) configured for storing decoded frames (34) from said decoder (31) and feeding an output (35) for decoded frames at nominal speed,
wherein the decoder (31) is configured
to stop feeding said buffer (33) and to continue reading from said encoded stream (30) at the beginning of a first or last GOP, depending on the playback direction, in said cut-out section being indicated by a skip-start mark configuring said stream when said mark is reached, and
to continue feeding said buffer (33) at nominal speed after decoding the last or first frame of said cut-out section configured by said skip-start mark, depending on the playback direction,
so that seamless playback skipping of said cut-out section is provided at said output (35).

12. The apparatus according to claim 9, wherein said apparatus is a Blu-ray recorder.

13. A computer-readable medium having embodied thereon a computer program for frame accurate editing an encoded A/V stream, for processing by a computer, the computer program comprising
a code segment for setting a mark indicating a start and duration of a sequence of frames to be skipped from said AV stream when playing said edited AV stream.

14. The computer program of claim 13 enabling carrying out of the method according to claim 1.

15. Use of marks as a means of achieving frame accurate editing of an encoded A/V stream.

16. Use according to claim 15, wherein said mark is a BD-RE skip-start mark.
